(19) United States
(12) Patent Application Publication
(10) Pub. No.: US 2012/0141178 A1
(43) Pub. Date: Jun. 7, 2012

(54) LUBRICANT SUPPLYING DEVICE AND IMAGE FORMING APPARATUS

(75) Inventors: Natsuko MINEGISHI, Tokyo (JP); Hisayoshi NAGASE, Tokyo (JP); Takashi AKAZAWA, Tokyo (JP)

(73) Assignee: KONICA MINOLTA BUSINESS TECHNOLOGIES, INC., Tokyo (JP)

(21) Appl. No.: 13/303,373

(22) Filed: Nov. 23, 2011

(30) Foreign Application Priority Data
Dec. 3, 2010 (JP) 2010-270036
Mar. 1, 2011 (JP) 2011-043656

(51) Int. Cl. G03G 21/00

(52) U.S. Cl. 399/346

(57) ABSTRACT

A lubricant supplying device that supplies a lubricant to the surface of an image carrier has a cloud generating section that generates a cloud in which particles of the lubricant are mixed with air and a conveying section that classifies the particles of the lubricant present in the cloud generated by the cloud generating section into small particles with sizes smaller than a prescribed size and large particles with sizes larger than or equal to the prescribed size, and conveys the classified small particles toward the image carrier, and has a lubricant supplying member that holds a lubricant, a contacting member that contacts the lubricant supplying member and causes the lubricant carried by the lubricant supplying member to fly off in the direction of the image carrier, and a leveling member that contacts the image carrier and levels the adhered lubricant.

This application is based on Japanese Patent Application Nos. 2010-270036 and 2011-043656 filed on Dec. 3, 2010 and Mar. 1, 2011 respectively with Japanese Patent Office, the entire content of which is hereby incorporated by reference.

### BACKGROUND OF THE INVENTION

The present invention relates to a lubricant supplying device that supplies a lubricant to an image carrier, and an image forming apparatus provided with such a lubricant supplying device.

Conventionally, in image forming apparatuses of the electro photographic method such as copying machines, printers, facsimile machines, and multifunction peripheries that combine the functions of these, a toner image is formed on an image carrier such as a photoreceptor or an intermediate image transfer member, etc., and after this toner image is transferred onto a paper, the toner image carried on the paper is fixed by a fixing device. Next, after fixing, the paper with image formed on it is discharged from the image forming apparatus.

After the toner image formed on the image carrier is transferred to a sheet of paper, there will be residual toner on the image carrier. Because of this, cleaning of this toner remaining after transfer is done using a cleaning blade or the like.

Conventionally, in an image forming apparatus, it is generally known that applying a lubricant on the surface of an image carrier has the effect of reducing the wear of the image carrier due to the cleaning blade, and in order to enhance the cleaning performance of this cleaning blade or to enhance the performance of transferring, and in order to reduce the wear of the surface of the image carrier or of the blade, many image forming apparatuses are provided with a lubricant supplying device to apply a lubricant on the surface of the image carrier.

During this application of the lubricant, if there is non-uniformity in the application and the coating becomes uneven, there will be differences in the width of wear of the cleaning blade locally, which makes it easy for cleaning defects to occur and the durability decreases. Because of this, while the lubricant is being applied, it is necessary to apply the lubricant uniformly on the surface of the image carrier. In addition, because of occurrence of the problem that the wear of the cleaning blade is increased if the amount of lubricant applied is too much, it is required to coat with the lubricant thinly in addition to coating uniformly.

As a method of coating said lubricant uniformly, the method of supplying the lubricant in the form of a powder to the surface of the image carrier is known.

Further, as a device for supplying (applying) the lubricant to the surface of the image carrier, a lubricant supplying device has been known that has a rotatable brush-shaped lubricant carrying member and an electrode that contacts the brush of said lubricant carrying member and, by not only applying an electric charge to the lubricant particles adhered to said brush by said electrode, but also by forming an electric field between the brush and the image carder, and causes the lubricant particles to migrate to the image carder utilizing electrostatic force (see Japanese Unexamined Patent Application Publication No. 2007-310336).

Further, as a device for supplying (applying) a lubricant to the surface of the image carrier, a lubricant supplying device has been known which has a lubricant supplying section that supplies stored lubricant to a rotatable brush-shaped lubricant carrier and allows the lubricant to be held by it, and said lubricant carrying member that causes the lubricant particles supplied to and held by the brush to fly toward the image carrier due to the centrifugal force generated by rotation (see Japanese Unexamined Patent Application Publication No. 2007-328098).

Further, as general knowledge, it is known that if the lubricant particles applied on the surface of the photoreceptor is excessive (too thick), the exposure light at the time of forming the latent image gets dispersed inside the thick lubricant layer, so that the focal point of the light arriving at the carrier generation layer inside the photoreceptor becomes blurred, which causes the latent image to be unclear, resulting that blur of the image occurs in the output image.

Further, technology has been known of providing a cleaning blade in the photoreceptor or intermediate image transfer member and thereby removing the residual developer.

Further, when the quantity of the lubricant particles applied is appropriate, the part of the cleaning blade in sliding contact with the photoreceptor or the intermediate image transfer member slightly lifts up and goes back repeatedly. However, if the applied lubricant particles are excessive (too thick), the part of the cleaning blade in sliding contact with the photoreceptor or the intermediate image transfer member remains in the turned over state, and it has been known that, as a result, the part in sliding contact comes off or its wear progresses abnormally.

In the lubricant supplying device disclosed in Japanese Unexamined Patent Application Publication No. 2007-310336, it has been disclosed that a brush-shaped rotating member (brush) carrying the lubricating agent (lubricant) is placed in a non-contacting manner opposite the image carrier and also at a position so that the lubricant held by it does not fall by gravity on the image carrier, and that not only an electric field is formed between the brush and the image carrier but also electrostatic force is used by applying an electric charge to the lubricating agent thereby transporting the lubricant particles from the brush to the image carrier. Since the lubricant particles to which electric charge has been applied by the electrode and which have been adhered to the brush are transported to the image carrier by electrostatic force, the larger the lubricant particle is, the easier it is transported, and there is possibility that a large quantity of large particles of the lubricating agent get adhered to the image carrier, and as a result, there were the problems that blur of the output image can occur due to the reasons described above when the lubricant layer becomes thick and that streaks can appear in the output images due to lack or wear of the cleaning blade.

Further, in the lubricant supplying device disclosed in Japanese Unexamined Patent Application Publication No. 2007-328098, since the lubricant particles held on a rotatable brush-shaped lubricant carrying member are made to fly toward the image carrier due to centrifugal force, there is possibility that a large quantity of lubricant particles are made to be adhered on the image carrier irrespective of whether the lubricant particles are large or small in size, and as a result, there was the problem that when the lubricant layer becomes thick blur of the output image occurs due to the reasons described above, and streaks described above appear in the output image.

In addition, in the lubricant supplying device disclosed in Japanese Unexamined Patent Application Publication No. 2007-310336, the lubricant particles are electrically charged, an electric field is formed between the brush and the image carrier, and the lubricant particles are transported and adhered to the image carrier using electrostatic force. However, when the electric field is formed using only direct current bias, the electrostatically charged lubricant particles are affected more easily by the electric field when they are larger in size, and when the electric field is formed in the direction of transporting the lubricant particles from the brush to the image carrier, they are more easily adhered to the image carrier when their size is larger.

In view of this, as has been explained above, in order to achieve reduction in the wear of the cleaning blade or reduction in the cleaning defects, it is important to apply the lubricant thinly and uniformly on the surface of the image carrier. In order to apply the lubricant thinly and uniformly, it is more effective if the particle diameter of the powder-shaped lubricant to be supplied to the image carrier is small.

However; as has been described above, in Japanese Unexamined Patent Application Publication No. 2007-310336, it is difficult to make lubricant particles of small diameter adhere selectively to the image carrier. In addition, since there will be partial differences in the amount of lubricant scraped off depending on the extent of dirt due to the adhesion of toner to the brush, it is difficult to coat the lubricant uniformly.

In addition, in Japanese Unexamined Patent Application Publication No. 2007-310336, it has been said that it is also possible to apply alternating current bias. However, although it is possible to cause selective adhesion of small diameter particles to the image carrier in the case of particles such as toner particles that have weak non-electrostatic adhesive strength, since lubricant particles have relatively high viscosity and mostly have a large non-electrostatic adhesive strength, it is difficult to make lubricant particles of small diameter adhere selectively to the image carrier even if such alternating current bias is applied.

### SUMMARY

The present invention was made in view of the problems described above, and an object of the present invention is to provide a lubricant supplying device which can apply the lubricant thinly and uniformly on the surface of the image carrier and which can provide high quality output images without an image blur or streaking defect, and to provide an image forming apparatus provided with said lubricant supplying device.

To achieve at least one of the abovementioned objects, a lubricant supplying system and an image forming apparatus reflecting one aspect of the present invention are as follows.

1. A lubricant supplying system including:

an image carrier, and

a lubricant supplying device for supplying a lubricant to a surface of the image carrier, the lubricant supplying device including:

a cloud generating section which generates a cloud in which particles of the lubricant are mixed with air; and

a conveying section which classifies the particles of the lubricant present in the cloud which is generated in the cloud generating section into small particles of less than a prescribed size and large particles of more than or equal to the prescribed size, and conveys the classified small particles toward the image carrier.

2. The lubricant supplying system described in the abovementioned Item 1,

wherein the cloud generating section, the conveying section, and the image carrier are arranged mutually separated from one another; and the cloud generating section, the conveying section, and the image carrier are arranged in this order in a direction of movement of the particles of the lubricant.

3. The lubricant supplying system described in the abovementioned Item 1,

wherein the conveying section includes:

an air current generating section which generates an air current at least a part of which flows toward the image carrier.

4. The lubricant supplying system described in the abovementioned Item 3,

wherein the air current generating section includes:

a plurality of blade members;

a blade supporting member which supports the blade members rotatably, and

a rotation driving member which rotates the blade supporting member at a prescribed constant rotational speed.

5. The lubricant supplying system described in the abovementioned Item 4,

wherein the air current is a circulating air current which circulates in surroundings of the blade members, and at least a part of the circulating air current is flown toward the image carrier.

6. The lubricant supplying system described in the abovementioned Item 3,

wherein the air current generating section generates the air current with an air velocity which ensures that the particles of the lubricant present in the cloud are classified into the small particles and the large particles and the classified small particles can be conveyed up to the image carrier and the classified large particles cannot be conveyed up to the image carrier.

7. The lubricant supplying system described in the abovementioned Item 1,

wherein the cloud generating section includes:

a plurality of elastic members;

a contacting member which comes in contact with tip sections of the elastic members;

a supporting member which supports the elastic members and enables the elastic members to move relative to the contacting member; and

a lubricant storage section which stores the lubricant and supplies the stored lubricant to the elastic members,

wherein the contacting member is arranged on a downstream side in a direction of movement of the elastic members with respect to the lubricant storage section.

8. The lubricant supplying system described in the abovementioned Item 7,

wherein the supporting member is a rotating member which is configured to rotate, and the elastic members are arranged radially at uniform intervals on a peripheral surface of the rotating member and forms a brush having elasticity

9. The lubricant supplying system described in the abovementioned Item 8 further including:

a brush driving member which rotates the brush via the rotating member at a prescribed constant rotational speed.

10. The lubricant supplying system described in the abovementioned Item 1 further including:

a casing for housing the cloud generating section and the conveying section; and

a lubricant sealing member which is arranged on a side of the casing which is opposed to the image carrier and prevents leaking of the particles of the lubricant to an outside of the casing,

wherein one end of the lubricant sealing member is fixed to the casing and another end is allowed to be in contact with the image carrier.

11. The lubricant supplying system described in the abovementioned Item 1,

wherein the image carrier is a photoreceptor.

12. The lubricant supplying system described in the abovementioned Item 11, further including:

a cleaning section which cleans a developer remaining on the photoreceptor; and

a charging section which uniformly charges the photoreceptor,

wherein the lubricant supplying device is arranged on a downstream side of the cleaning section and on an upstream side of the charging section in a direction of rotation of the photoreceptor.

13. The lubricant supplying system described in the abovementioned Item 1,

wherein the image carrier is an intermediate image transfer member.

14. The lubricant supplying system described in the abovementioned Item 13, further including:

a cleaning section which cleans a developer remaining on the intermediate image transfer member, and

a photoreceptor which transfers an image onto the intermediate image transfer member,

wherein the lubricant supplying device is arranged on a downstream side of the cleaning section and on an upstream side of the photoreceptor in a direction of rotation of the intermediate image transfer member.

15. An image forming apparatus including the lubricant supplying system described in the abovementioned Item 1.

### BRIEF DESCRIPTION OF THE DRAWINGS

FIG. 1 is an explanatory drawing of an image forming apparatus according to the first preferred embodiment.

Each of FIGS. 2a and 2b is an explanatory drawing (side view diagram) of a lubricant supplying device according to the first preferred embodiment.

FIGS. 3a and 3b are explanatory diagrams of a blade member which is an air current generating member.

Each of FIGS. 4a-4c is an explanatory diagram (side view diagram) showing the positional relationship between the lubricant supplying device and the photoreceptor.

Each of FIGS. 5a and 5b is a diagram of the lubricant supplying devices used in the comparison examples.

FIG. 6 is a diagram of a halftone image used for evaluation.

FIG. 7 is a diagram showing an example of the image forming apparatus according to the second preferred embodiment.

FIG. 8 is an enlarged view diagram of the surroundings of the photoreceptor drum of the Implementation Example 1.

FIG. 9 is a schematic diagram expressing the flying of the lubricant.

Each of FIGS. 10a-10d is a graph showing the particle diameter distribution of the lubricant adhered to the photoreceptor drum of the Implementation Example 1.

FIG. 11 is a table diagram showing the results of evaluation of the Implementation Example 1.

FIG. 12 is an enlarged view diagram of the surroundings of the photoreceptor drum of the Implementation Example 2.

Each of FIGS. 13a and 13b is a graph showing the particle diameter distribution of the lubricant adhered to the photoreceptor drum of the Implementation Example 2.

FIG. 14 is a table diagram showing the results of evaluation of the Implementation Example 2.

### DETAILED DESCRIPTION OF THE PREFERRED EMBODIMENT

The present invention is intended to provide a lubricant supplying device that can form lubricant layer on an image carrier uniformly and also thinly.

### First Preferred Embodiment

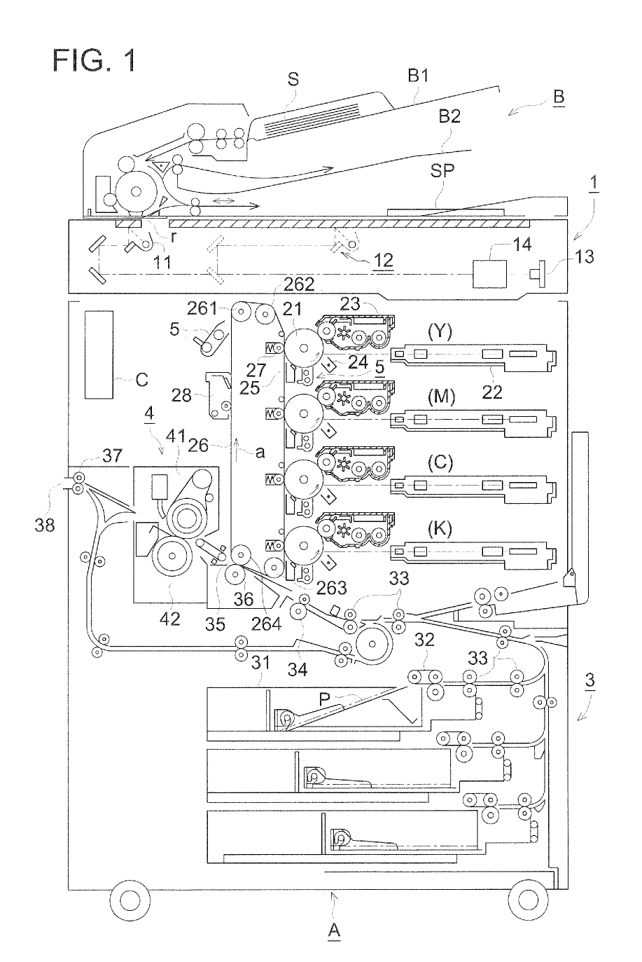

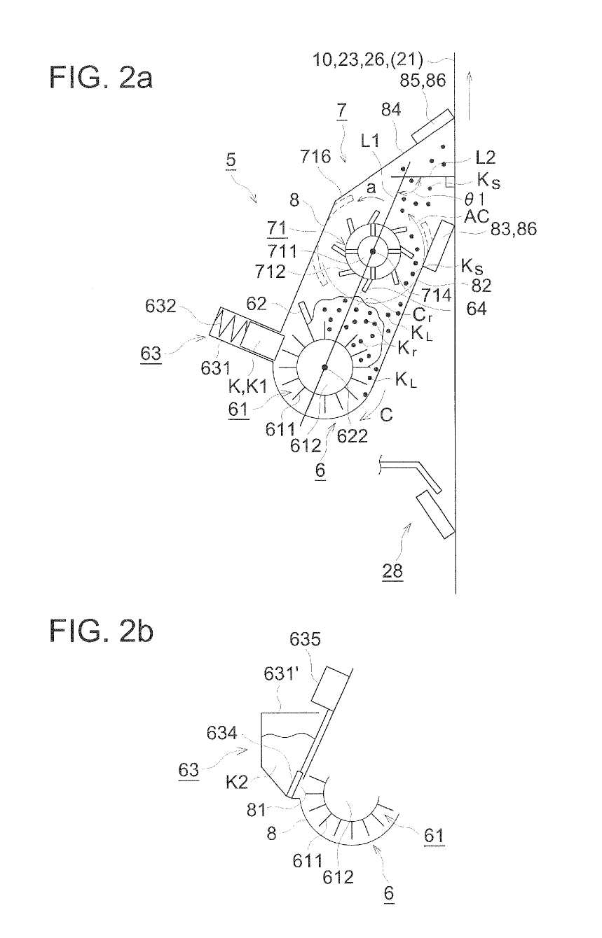

FIG. 1 is an explanatory drawing of an image forming apparatus according to the first preferred embodiment.

The descriptions are given taking an example of the following image forming apparatus A which is known as a tandem type full color copying machine as an example of the image forming apparatus.

The automatic document feeding apparatus B picks up sheets of the document S placed on the sheet feeding tray B1 one by one, conveys it to the document reading region “r”, and discharges to the sheet discharge tray B2, the document S whose image information has been read in the document reading region “r”.

The document image reading section 1 has a light source 11, a movable scanning unit 12, and an optical system 14 that focuses the document image onto the line image sensor 13.

For example, in the case of a stationary optical system type reading operation, the scanning unit 12 is kept fixed at the document reading region “r”, and the image of the document S conveyed by the automatic document feeding apparatus B is read. Further, in the case of the moving optical system type reading operation, the image of the document S placed on the document image reading section 1 is read out while moving the scanning unit 12.

The analog signal of the document image obtained by photoelectric conversion by the line image sensor 13 is subjected to analog signal processing, A/D conversion, shading correction, image compression processing, etc., and becomes digital image data of each color of yellow (Y), magenta (M), cyan (C), and black (K).

The exposure sections 22 (22Y, 22M, 22C, and 22K) that form latent images on drum shaped photoreceptors 21 (21Y, 21M, 21C, and 21K) as the first image carriers based on the digital image data of each color, the developing sections 23 (23Y, 23M, 23C, and 23K) that develop the latent images corresponding to each color by using toners, the charge sections 24 (24Y, 24M, 24C, and 24K) that uniformly charge the photoreceptors 21, and the cleaning sections 25 (25Y, 25M, 25C, and 25K) that remove the toner that is not transferred onto the intermediate image transfer member 26 but remain on the surfaces of the photoreceptors 21 are positioned.

Further, lubricant supplying devices 5 that supply a lubricant to the surfaces of the photoreceptors 21 are placed on the downstream side of the cleaning section 25 and also on the upstream side of the charging section 24 along the direction of rotation of each photoreceptor 21.

Further, opposite to each of the photoreceptors 21 (21Y, 21M, 21C, and 21K), a semiconducting endless belt-shaped intermediate image transfer member 26 is placed that is supported in a rotatable manner by rollers 261, 262, 263, and 264, and this intermediate image transfer member 26 is driven in the direction of the arrow “a” via the roller 263 by a driving device not shown in the figure.

The toner images for each color carried by the each of photoreceptors 21 are successively transferred to the intermediate image transfer member 26 by the pressure of the primary transfer rollers 27 (27Y, 27M, 27C, and 27K), and a synthesized color image is formed.

The toner that has not been transferred to the recording material but has remained on the intermediate image transfer member 26 is removed by the cleaning unit 28.

Further, a lubricant supplying device 5 that supplies a lubricant to the surface of the intermediate image transfer member 26 is installed on the downstream side of the cleaning section 28 and also on the upstream side of the photoreceptor 21 that is the uppermost one on the upstream side in the direction of rotation of the intermediate image transfer member 26.

The sheet feeding section 3 has a plurality of sheet feeding cassettes 31 which are sheet storing members, and recording materials are stored inside the sheet feeding cassettes 31.

The recording material can be plastic sheets, sheet shaped paper or others, and the recording material is referred to as paper P in the following.

One sheet of the stored paper P at a time is picked up by the sheet feeding roller 32, conveyed via a plurality of conveying rollers 33 and a registration roller 34 up to the transfer regions 35, and the toner image synthesized on the intermediate image transfer member is transferred at a time onto the conveyed paper P by the pressure of the secondary transfer roller 36.

The paper P onto which a toner image has been transferred is separated from the intermediate image transfer member 26 at a curvature point, and the toner image is fixed on the paper P by the application of heat and pressure by the heating section 41 and the pressing section 42 of the fixing device 4.

Next, the paper P onto which the toner image has been fixed is gripped by the sheet discharge rollers 37 and is discharged to outside the apparatus from the sheet discharge outlet 38.

The image forming apparatus A has an operation panel SP that displays various information and through which the user inputs various information according the displayed contents.

Further, the operations described above are controlled by a control section C which controls the entire image forming apparatus.

Although the above explanations were given taking the example of a tandem type full color copying machine, it goes without saying that the lubricant supplying device 5 can be used in a monochromatic copying machine.

Each of FIGS. 2a and 2b is an explanatory drawing (side view diagram) of a lubricant supplying device.

The lubricant supplying device is described referring to FIG. 2a.

The lubricant supplying device 5 is a device that supplies a lubricant to the surface of the photoreceptors or of the intermediate image transfer member which are image carriers, and has a cloud generating section 6 that generates a cloud Cr in which particles of a lubricant are mixed with air, and a conveying section 7 that classifies the lubricant particles Kr present in the cloud Cr into small particles of less than a prescribed size and large particles of more than or equal to the prescribed size, and conveys the classified small particles toward the image carrier.

Further, zinc stearate is preferably used as the lubricant, and is supplied as a solid lubricant formed in the shape of a rod or as a powder lubricant in the form of powder.

Further, the cloud generating section 6 and the conveying section 7 are housed in the lubricant supplying casing 8 that is fixed to the casing of the image forming apparatus, the cloud generating section 6, the conveying section 7, and the image carrier 10 are placed so that they are separated from one another, and the cloud generating section 6, the conveying section 7, and the image carrier 10 are positioned in the direction of movement of the lubricant particles Kr in this order.

In the following, when it is not particularly necessary to specifically identify the image carrier 10 as the photoreceptor 21 or as the intermediate image transfer member 26, both the photoreceptor 21 and the intermediate image transfer member 26 are simply referred to as the image carrier 10.

In the following, explanations are given taking the example of the case when the image carrier 10 is the intermediate image transfer member 26.

The cloud generating section 6 has a lubricant emitting section 61 that emits a prescribed quantity of lubricant particles per unit time toward the conveying section 7 while the intermediate image transfer member is rotating, and a lubricant supplying section 63 that stores the lubricant and causes the stored lubricant to get adhered to the elastic members 611.

The lubricant emitting section 61 (the cloud generating section 6) has a plurality of elastic members 611, a contacting member 62 that is in contact with the tip part of the elastic members 611, and an elastic body supporting member 612 that makes it possible to relatively move the elastic members 611 with respect to the contacting member 62.

Then, because the tips of the plurality of elastic members 611 mounted on the rotating elastic body supporting member 612 comes in contact with said contacting member, the lubricant particles Kr adhered to the elastic members 611 are emitted toward the conveying section 7.

Further, the contacting member 62 is installed on the downstream side in the direction of movement of the elastic members 611 relative to the lubricant supplying section 63.

It is sufficient if the elastic body supporting member 612 is such that the elastic members 611 can move relative to the contacting member 62, and can be a flat plate-shaped elastic body supporting member 612 that carries out reciprocating movement parallel to the surface, or a flat plate-shaped elastic body supporting member 612 that rotates parallel to the surface, or can be a cylindrical rod-shaped elastic body supporting member 612 that rotates.

As a cylindrical rod-shaped elastic body supporting member 612 that rotates, a brush-shaped rotating member in which fiber-like brush bristles are implanted in a radial manner on an elastic body supporting member 612 and a plate-shaped rotating member in which flat plate-shaped members having elasticity are fixed in a radial manner to an elastic body supporting member 612 are possible. However, the case is described where brush-shaped rotating member in which brush bristles are implanted in a radial manner on an elastic body supporting member 612 is used.

In other words, the supporting member (brush-shaped rotating member) that supports the brush bristles 611 which are elastic members is a rotating shaft that can rotate, and the elastic members are the brush bristles 611 with elasticity arranged with a uniform pitch in a radial manner on the circular circumferential surface of said rotating shaft.

In the following, the an elastic body supporting member having brush bristles implanted on it in a radial manner which is one form of the elastic body supporting member 612 is called the brush supporting member 612, and the brush bristles which are one form of the elastic member 611 are called the brush 611.

The brush supporting member 612 has the shape of a cylindrical rod with a diameter of, for example, about 8 mm, and in the circumferential and axial directions on its periphery, brush bristles 611 with a length of, for example, about 3 mm are implanted uniformly.

The brush bristle 611 which are elastic members are constituted of thin plastic fibers, and these fibers are, for example, acryl carbon fibers with thicknesses of about 3 deniers and lengths of about 3 mm, and about 115,000 of them are implanted per 6.45 cm² of the brush supporting member 612.

Further, the brush supporting member 612 is rotated by a brush driving member not shown in the figure so that, the direction of the cloud Cr generated by the brush bristles 611 is in the same direction as the air current generating member 71 in the part where the air current generating member 71 of the conveying section 7 and the brush bristles are opposed to each other, that is, so that the direction of rotation of the brush 611 is opposite to the direction of rotation of the air current generating member 71.

Further, the preferable rotational speed of the brush supporting member 612 (brush 611) by the brush driving member not shown in the figure is described below.

The contacting member 62 is constituted of a plate shaped or a cylindrical rod shaped metal (for example, stainless steel) or plastic with a high rigidity, and is positioned as described above on the downstream side of the lubricant supplying section 63 in the direction of rotation (direction of the arrow mark c) of the brush supporting member 612, and also on the upstream side of the area 64 where the cloud generating section 6 and the conveying section 7 are opposed to each other.

Here, the brush 611 and the contacting member 62 are placed separated so that the tip side 1 mm of the length of about 3 mm of the brush 611 is in contact with the contacting member 62.

Further, the lubricant supplying section 63 has a lubricant storing member 631 that stores the lubricant K, and a pushing member 632 that pushes the solid lubricant K1 toward the cloud generating section 6.

Further, the lubricant supplying section 63 is fixed to a lubricant supplying casing 8, and the part of the lubricant supplying casing that is fixed to the lubricant supplying section 63 has an opening so that the solid lubricant K1 can be pushed toward the brush 611.

The pushing member 632, in the case in which the lubricant K is a solid, is an elastic body that presses the solid lubricant K1 against the brush 611 with a prescribed pushing pressure, and constituted of, for example, a compressed spring, so that it pushes the solid lubricant K1 installed in the lubricant storing member 631 toward the brush 611 with a prescribed pushing pressure (for example, 0.64 N).

Further, in order to generate a cloud Cr that is uniform over the entire width of the intermediate image transfer member 26 and also uniform in time, the lengths in the depth direction in the figure of the solid lubricant K1, the brush 611, and the contacting member 62 are longer than the length in the width direction (the perpendicular direction to the figure) of the intermediate image transfer member 26.

Further, for a similar purpose, the pushing member 632 pushes the solid lubricant K1 with a constant pushing pressure, and the brush 611 is rotated at a constant rotational speed.

The preferable speed of rotation of the brush supporting member 612 (brush 611) by a brush driving member not shown in the figure differs depending on the shape of the lubricant supplying casing 8, the dimensions and shape of the brush supporting member 612, the material, dimensions, and shape of the brush 611, and the distance between the brush 611 and the blade member 712 of the air current generating section 71, and so on.

Because of this, as has been explained earlier, the rotational speed is determined in advance by experiments or the like so that a prescribed quantity of the lubricant particles Kr adheres uniformly to the surface of the brush 611, and also, a cloud Cr is generated with the lubricant particles Kr mixed with air with a prescribed density.

In other words, the rotational speed of the roller that rotationally drives the intermediate image transfer member 26, the rotational speed of the brash 611, and the pushing pressure of the pushing member 632 are determined in advance by experiments so that the quantity of lubricant particles Kr scraped off by the brush 611 ensures that the quantity, that is the thickness, of small particles Ks adhered to the intermediate image transfer member 26 is of a prescribed value. The quantity scraped off is determined by the rotational speed of the brush 611 and the pushing pressure of the pushing member 632 with respect to the movement area of the intermediate image transfer member 26 per unit time, which is determined by the product of multiplication of the distance of movement of the surface of the intermediate image transfer member 26 per unit time and the length in the width direction (in the depth direction in the figure) of the intermediate image transfer member 26. The distance of movement is determined by the speed of movement of the intermediate image transfer member 26 (the rotational speed of the roller that drives the intermediate image transfer member 26).

Next, the rotational speed of the brush driving member not shown in the figure is set to that rotational speed, and the setting is made so that the pushing pressure of the pushing member 632 becomes equal to that pushing pressure.

Here, the prescribed value is a value that can prevent image blur or the generation of streaking defects.

Under the conditions described above of the respective constituent members, the rotational speed of the brush supporting member 612 (brush 611) is set, for example, to 500 to 1500 rpm, preferably to about 550 rpm.

The operation of the cloud generating section 6 is described in the following.

(1) The brush 611 rotates at a fixed prescribed rotational speed (for example, 550 rpm) due to the brush driving member not shown in the figure that rotates brush 611.

(2) Because the surface of the solid lubricant K1, which is pushed with a prescribed pushing pressure (for example, 0.64 N) toward the brush 611, is scraped by the tip part of the rotating brush 611, a prescribed quantity of the lubricant particles Kr get adhered uniformly to the surface of the brush 611.

(3) Subsequently, the contacting member 62 scrapes the tip part of the brush 611, and the tip part is flicked, and then the prescribed quantity of lubricant particles Kr that had gotten adhered uniformly to the brush 611 is discharged to the interior of the lubricant supplying casing 8, and a cloud Cr is generated in which the lubricant particles Kr are mixed with air uniformly and with a prescribed density.

As a result of scraping the solid lubricant K1 in a cloud generating section 6 with the constitution and conditions described above, it was confirmed that it was possible to generate a cloud Cr having lubricant particles Kr in which the number of particles having a diametrical length at the largest external shape part of more or less 20 μm is the greatest.

FIG. 2b is an outline schematic diagram of another form of the lubricant storage member.

When the lubricant K is a powder, a lubricant storing member 631′ that stores powdered lubricant K2, a slit shaped injection inlet 81 that has been opened in the lubricant supplying casing 8 and that injects powdered lubricant K2 into the cloud generating section 6, a shutter 634 that opens and closes the injection inlet 81, and a driving member 635 (for example, a solenoid) that opens and closes the shutter 634 are provided.

Further, by opening the shutter 634 during the operation of the intermediate image transfer member 26, the amount of the powdered lubricant K2 determined by the area of opening of the injection inlet 81 is supplied.

Further, the area of opening of the injection inlet 81 is obtained in advanced by experiments so that the quantity of the powdered lubricant K2 that passes through the opening of the injection inlet 81, consequently the quantity of small particles Ks that adhere to the intermediate image transfer member 26 out of the powdered lubricant K2, in other words, its thickness, becomes the prescribed value, and the opening of the injection inlet 81 is provided so that the area of the opening becomes equal to that obtained area.

Here, the prescribed value is a value such that image blur or streaking defects do not occur.

Returning to FIG. 2a, the conveying section 7 has an air current generating section 71 that generates a current of air at least a part of which flows toward the image carrier 10.

The air current generating section 71 has a plurality of blade members 712, a rotating shaft 711 that is a blade supporting member that supports the blade members 712 in a rotatable manner, and a rotationally driving member not shown in the figure that drives the rotating shaft 711 at a constant prescribed rotational speed.

Further, a circulating air current AC is generated due to rotation of the blade members 712, the lubricant particles Kr are classified into small particles Ks and large particles K_{L} by the circulating air current AC, the small particles Ks are conveyed toward the intermediate image transfer member 26, and the small particles Ks are made to adhere to the intermediate image transfer member 26.

The air current generating section 71 of the conveying section 7 and the brush supporting member 612 of the cloud generating section 6 are placed with a separation distance such that it is possible to make mainly the small particles Ks in the cloud Cr generated by the cloud generating section 6 get into the circulating air current AC generated by the air current generating section 71. For example, the minimum separation distance from the tip of the brush 611 to the tip of the opposite blade member 712 is made equal to or more than 0.5 mm but not more than 5 mm, preferably 1 to 3 mm.

Because of providing such a distance of separation, while the small particles Ks get into the part of the circulating air current AC, most of the large particles K_{L}, are not included in the circulating air current AC but can fall freely from between the brushes 611 and the blade members 712.

In addition, the air current generating member 71 and the intermediate image transfer member 26 are placed with a prescribed separation distance between them such that the classified small particles Ks can get into the air current flowing toward the intermediate image transfer member 26 in the circulating air current AC and can be conveyed up to the intermediate image transfer member 26, and also such that the freely falling large particles K_{L}, do not get adhered to the intermediate image transfer member 26. They are placed, for example, such that the minimum separation distance from the tip of the blade member 712 to its opposite intermediate image transfer member 26 is equal to or more than 0.5 mm but not more than 5 mm, preferably 1 to 2 mm.

Due to the rotation of the blade members 712, a circulating air current AC that circulates on the periphery of the blade members 712 is generated, and at least a part of the circulating air current AC flows toward the image carrier 10.

Further, said rotation driving member not shown in the figure rotates the air current generating member 71 so that the direction of the air current generated by the air current generating section 71 (the circulating air current AC) is the same as the direction of movement of the intermediate image transfer member 26 in the part where the intermediate image transfer member 26 and the air current generating member 71 are opposed to each other.

Said rotation driving member not shown in the figure rotates the blade members 712 and generates a circulating air current with an air flow speed that can classify the lubricant particles Kr present in the cloud Cr into small particles Ks with less than a prescribed size and larger particles K_{L} with more than or equal to the prescribed size, and also, at least a part of the circulating air current AC can generate an air flow speed that can convey the classified small particles Ks toward the image carrier 10.

In other words, said rotation driving member not shown in the figure rotates the blade members 712 at a rotational speed that can generate a circulating air current AC that classifies the lubricant particles Kr into small particles Ks and large particles K_{L}, and conveys the small particles Ks up to the intermediate image transfer member 26.

Further, in order to make the air current generated by the air current generating section 71 into a circulating air current AC that circulates inside the conveying section 7 efficiently, guides 716 (broken lines) that extend along the circumferential direction and are placed at a distance from the air current generating section 71 can be provided.

The guides 716 (broken lines) have openings on the cloud generating section 6 side and on the intermediate image transfer member 26 side, and it is possible for the cloud Cr generated by the cloud generating section 6 to enter the conveying section 7, and for the small particles Ks to be conveyed from the conveying section 7 to the intermediate image transfer member 26.

Further; it is sufficient if the air current generating member 71 can generate the circulating air current AC, a fan, a sirocco fan, or the like for this can be used, and in this case, a circulating air current AC can be obtained efficiently particularly by providing the guides 716.

Because the cloud generating section 6 (brush 611) and the air current generating section 71 (blade members 712) are placed as explained above at a prescribed distance, and the air current generating member 71 (blade members 712) and the intermediate image transfer member 26 are placed as explained above at a prescribed distance as well, although the small particles Ks get in said circulating air current AC generated by the air current generating member 71 and are conveyed up to the distant intermediate image transfer member 26 because they are light, the large particles K_{L} cannot get in the circulating air current AC generated by the air current generating member 71 because they are heavy, and fall freely along the lubricant supplying casing 8, and are not conveyed up to the distant intermediate image transfer member 26.

The lubricant supplying device 5 is placed at a prescribed angle to the vertical line so that the large particles K_{L} that do not get adhered to the intermediate image transfer member 26 and fall freely inside the lubricant supplying casing 8 do not get close again to the intermediate image transfer member 26.

To be more specific, the lubricant supplying device 5 is placed with respect to the intermediate image transfer member 26 such that the angle θ1 between the line L1 connecting the center of rotation 622 of the brush supporting member 612 with the center of rotation 714 of the rotating shaft 711 and the vertical line L2 perpendicular to the intermediate image transfer member 26 is in the range of 90° to 180°, preferably 90° to 160°.

By setting the angle θ1 in this manner, even when the image earner is placed vertically like the intermediate image transfer member 26, it is possible to make the large particles K_{L}, not to get adhered to the intermediate image transfer member 26 but to make only the small particles Ks to get adhered to the intermediate image transfer member 26.

Incidentally, when the large particles K_{L} are falling freely, since they repeatedly collide with the lubricant supplying casing 8 or the brush 611 or the like, they are broken and a part of the particles of the large particles K_{L}, becomes small to the extent of the small particles Ks.

The particles that have become small (small particles Ks) get adhered to the brush 611 of the cloud generating section 6, and similar to the lubricant particles Kr getting conveyed to the conveying section 7, get conveyed again to the conveying section 7, and are further conveyed up to the intermediate image transfer member 26.

In this manner, by generating the circulating air current AC in the conveying section 7, since it has been made possible to reduce the size of the large particles and make them small particles, it became possible to increase the efficiency of use of the solid lubricant K1.

As has been explained above, while the conveying section 7 has both the function of classifying the lubricant particles Kr present in the cloud Cr generated by the cloud generating section 6 and the function of conveying them up to the intermediate image transfer member 26, within the region from the conveying section up to the intermediate image transfer member 26, the function of classifying becomes the major function in the region near the brush 611 rather than the function of conveying, and the function of conveying becomes the major function in the region far from the brush 611 rather than the function of classifying the particles.

The lubricant supplying device 5 has the lubricant supplying casing 8 which is a casing for housing the cloud generating section 6 and the conveying section 7, and on the side of the lubricant supplying casing 8 opposed to the intermediate image transfer member 26 is installed a lubricant sealing member 86 whose one end part is fixed to the lubricant supplying casing 8 and whose other end is in contact with the intermediate image transfer member 26 thereby preventing the leakage of the lubricant particles Kr to outside the lubricant supplying casing 8.

Further, the lubricant sealing member 86 is made of an elastic material such as, for example, rubber, and is set at an angle so that the large particles K_{L} that were not conveyed to the intermediate image transfer member 26 cannot get adhered to the intermediate image transfer member 26.

Said angle at which the large particles K_{L} cannot get adhered to the intermediate image transfer member 26 is the angle at the contact point where the intermediate image transfer member 26 contacts the lubricant sealing member 86, formed between the lubricant sealing member 86 and the part of the intermediate image transfer member 26 on the upstream side of said contact point, is set in the range of 0 to 90°.

Further, the lubricant sealing member 86 positioned on the upstream side end part 82 in the direction of movement (arrow mark) of the intermediate image transfer member 26 forms a first blade 83 having the shape of a blade that becomes thinner at the tip.

The first blade 83 also has the function of a cleaning blade that removes the developer that was not completely removed by the cleaning section 28.

Further, in order to simplify the construction of the image forming apparatus A, it is also possible not to provide a cleaning section 28, but to remove the developer remaining on the intermediate image transfer member 26 using the first blade 83.

Further, the lubricant sealing member 86 positioned on the downstream side end part 84 in the direction of movement (arrow mark) of the intermediate image transfer member 26 forms a second blade 85 having the shape of a blade that becomes thinner at the tip.

By being in sliding contact with the lubricant adhered to the surface of the intermediate image transfer member 26, the second blade 85 has the function of leveling said lubricant uniform.

Since the lubricant has a relatively high viscosity, because the second blade 85 is in sliding contact with the lubricant adhered to the surface of the intermediate image transfer member 26, it is possible to extend the lubricant and to form a thin and uniform layer of lubricant coating.

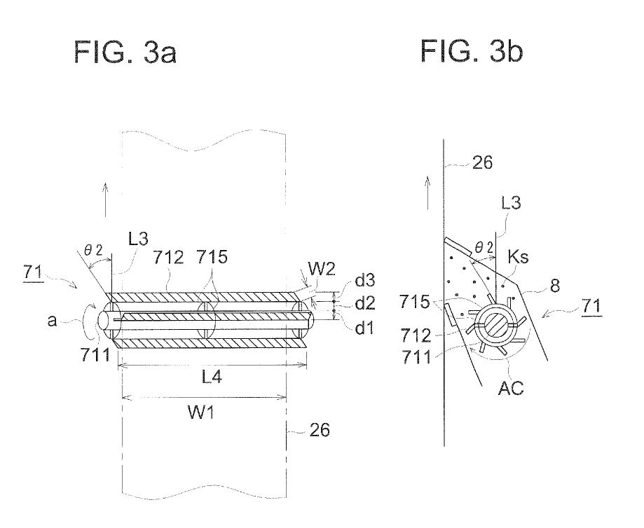

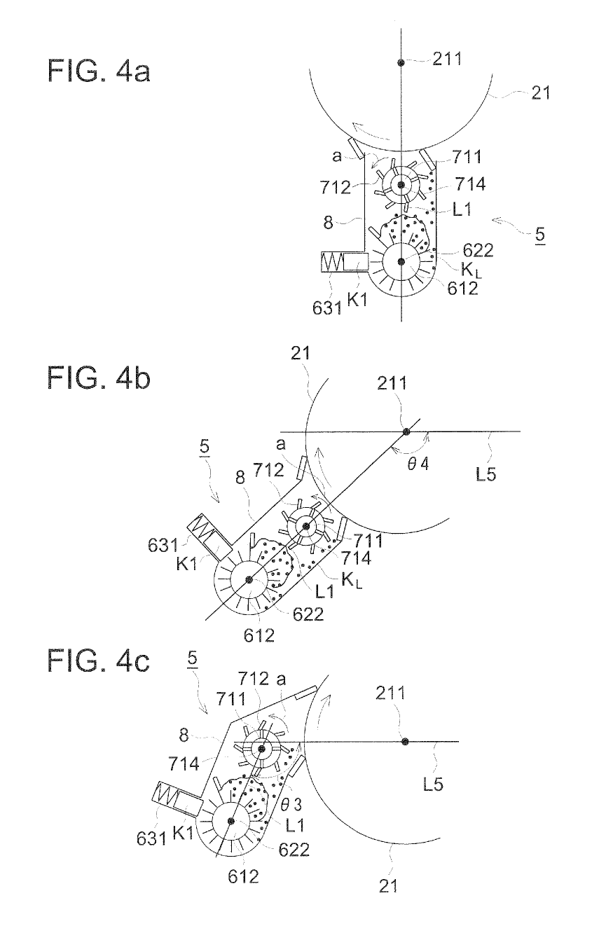

FIGS. 3a and 3b are explanatory diagrams of a blade member of an air current generating member.

The conveying section 7, in order that the cloud Cr which has been generated by the cloud generating section 6 and in which the lubricant particles Kr are distributed in air uniformly and with a prescribed density is drawn in and that a lubricant layer is applied uniformly and thinly on the intermediate image transfer member 26, it is necessary to generate a circulating air current AC with a constant air flow speed and uniform without any irregularities in the width direction (the depth direction in the figure) of the intermediate image transfer member 26. Because of this, the air current generating member 71 is described in detail referring to FIGS. 3a and 3b.

FIG. 3a is a perspective view of the air current generating member 71 shown in FIG. 2a as viewed diagonally from the right front, and FIG. 3b is a diagram of the air current generating member of FIG. 3a as viewed from the left side.

Further, in FIG. 3a, in order to make the drawing simple, only three of the plurality of blade members 712 have been shown.

In FIGS. 3a and 3b, the air current generating member 71 has a rotating shaft 711, a plurality of blade members 712 (the hatched parts), and a supporting member 715.

Further, the rotating shaft 711 is supported by the lubricant supplying casing 8 in a rotatable manner, the plurality of blade members 712 are fixed to the rotating shaft 711 via the supporting member 715, and the blade members 712 are rotated by a driving member not shown in the figure via the rotating shaft 711.

Further, the direction of rotation of the blade members 712 is such that, at the part where the blade members 712 are opposed to the intermediate image transfer member 26, the direction of movement (arrow) of the intermediate image transfer member 26 and the direction of rotation of the blade members 712 (the direction of the arrow “a”) are the same.

The dimensions in the diametrical direction of the respective parts of the air current generating member 71 are, for example, the radius d1 of the rotating shaft 711 being 2 mm, the length d2 of the supporting member 715 being 3.5 mm, and the length d3 of the blade member 712 being 1.5 mm.

Further, the plurality of, for example, eight blade members 712 have the same shape and dimensions as one another, are fixed with a constant pitch on the rotating shaft 711, and generate the circulating air current AC by rotating in the direction of the arrow mark “a”.

Further, each of the plurality of blade members 712 has been provided along the entire length of the rotating shaft 711, the lengths L4 of the plurality of blade members 712 are all the same and longer than the width W1 of the intermediate image transfer member 26 (between the dot and dash lines), and the widths W2 of the plurality of blade members 712 are all the same (for example, 3 mm).

Further, in order that the plurality of blade members 712 efficiently generate the circulating air current AC, they are fixed to the supporting member 715 with a prescribed angle θ2 with respect to the straight line L3 which is the diametrical direction of the rotating shaft 711.

Since the optimum angle as the prescribed angle θ2 differs also depending on the shape of the lubricant supplying casing 8 and the shape of the blade members 712, experiments should be conducted in advance, and the angle at which the small particles Ks can be separated from the lubricant particles Kr is determined and also a circulating air current AC which makes it easy for the small particles Ks to be conveyed to the intermediate image transfer member 26 is generated.

For example, regarding the said shape and dimensions of the blade members 712, the blade members 712 are fixed to the rotating shaft 711 via the supporting member 71 so that said angle θ2 becomes 0° to 60°, preferably 30°.

In this manner, by providing the angle θ2, the circulating air current AC is generated efficiently due to the rotation of the blade members 712, and also, it is possible to classify the small particles Ks present in the circulating air current AC and to convey them toward the intermediate image transfer member 26.

Further, by rotating the air current generating section 71 with the construction described above at a prescribed constant speed (for example, 550 rpm), a constant circulating air current AC uniformly along the width direction of the intermediate image transfer member 26 with the prescribed air flow speed and without irregularity can be generated.

Although so far explanations were given for the construction in which the blade members 712 are fixed to the rotating shaft 711 via a supporting member 715, the blade members 712 can be fixed directly to the rotating shaft 711.

In this case, by experiments in advance, the dimensions, shape, and the angle θ2 are so set that it is possible to generate a circulating air current AC with an air flow speed that allows the small particles Ks to be classified and also the small particles Ks to be conveyed to the intermediate image transfer member 26.

Each of FIGS. 4a-4c is an explanatory diagram (side view diagram) showing the positional relationship between the lubricant supplying device and the photoreceptor.

In order that the large particles K_{L} that did not get adhered to the receptor 21 do not get close again to the photoreceptor 21, the center of rotation of the photoreceptor 21 is positioned higher than the center of rotation of the air current generating member 71.

In addition, so that the large particles K_{L} that did not adhered do not get close again to the photoreceptor 21 even after falling freely inside the lubricant supplying casing 8, the lubricant supplying device 5 is placed with a prescribed angle to the horizontal line.

In the following, the positional relationship between the lubricant supplying device 5 and the photoreceptor 21 is described for the case when a lubricant supplying device 5 is provided for the photoreceptor 21.

Sine the lubricant supplying device 5 has a construction similar to that referred to in FIGS. 2a and 2b excepting only that the shape of the end part of the lubricant supplying casing 8 on the image carrier side is slightly different, the detailed descriptions of the cloud generating section 6 and the conveying section 7 are omitted excepting the differing parts.

The direction of rotation (the direction of the arrow mark “a”) of the rotating shaft 711 is opposite to the direction of rotation (arrow mark) of the photoreceptor 21 so that, in the part where the blade members 711 are opposed to the photoreceptor 21, the direction of movement of the surface of the photoreceptor 21 and the direction of movement of the tips of the blade members 712 are the same.

FIG. 4a shows the case in which the center of rotation 211 of the photoreceptor 21 is positioned on the extension of the straight line L1 connecting the center of rotation 622 of the brush supporting member 612 and the center of rotation 714 of the rotating shaft 711.

This positional relationship is used favorably when the lubricant supplying device 5 is placed below the photoreceptor 21, and for example, the lubricant supplying device 5 is installed relative to the photoreceptor 21 so that the center of rotation 211 of the photoreceptor 21, the center of rotation 622 of the brush supporting member 612, and the center of rotation 714 of the rotating shaft 711 all are on a vertical line (a line at right angles to the horizontal line).

In this case, since the lubricant supplying device 5 is placed below the photoreceptor 21, because the large particles K_{L} are not conveyed to the photoreceptor 21 but fall freely inside the lubricant supplying device 5, there is no possibility of their getting close again to the photoreceptor 21.

FIG. 4b shows the case in which the center of rotation 211 of the photoreceptor 21 is positioned on the extension of the straight line L1 connecting the center of rotation 622 of the brush supporting member 612 and the center of rotation 714 of the rotating shaft 711, and also, the extension of the straight line L1 and the horizontal line L5 passing through the center of rotation 211 of the photoreceptor 21 intersect at a prescribed angle.

This positional relationship is used favorably when the lubricant supplying device 5 is placed diagonally below the photoreceptor 21.

In order to make the large particles K_{L} that were not conveyed to the photoreceptor 21 fall to inside the lubricant supplying apparatus 5 along the inclined lubricant supplying casing 8, the lubricant supplying device 5 is installed with respect to the photoreceptor 21 so that the angle of installing the lubricant supplying device 5 with respect to the photoreceptor 21, that is, the angle θ4 between the straight line L1 and the horizontal line L5 becomes, for example, 90° or more but less than 180°, preferably, 90° or more but less than 150°.

Because of setting the angle θ4 in this manner, even when the lubricant supplying device 5 is placed diagonally below the photoreceptor 21, since the large particles K_{L} that were not conveyed to the photoreceptor 21 fall to inside the lubricant supplying apparatus 5 along the inclined lubricant supplying casing 8, they do not get close again to the photoreceptor 21, and only the small particles Ks can get adhered to the photoreceptor 21.

FIG. 4c shows the case in which the center of rotation 211 of the photoreceptor 21 is not positioned on the extension of the straight line L1 connecting the center of rotation 622 of the brush supporting member 612 and the center of rotation 714 of the rotating shaft 711, and also the extension of the straight line L1 and the horizontal line L5 passing through the center of rotation 211 of the photoreceptor 21 intersect at a prescribed angle.

This positional relationship is used favorably when the lubricant supplying device 5 and the photoreceptor 21 are placed at roughly the same height positions.

In order to make the large particles K_{L}, that were not conveyed to the photoreceptor 21 fall to inside the lubricant supplying apparatus 5 along the inclined lubricant supplying casing 8, the lubricant supplying device 5 is installed with respect to the photoreceptor 21 so that the angle θ3 between the horizontal line L5 passing through the center of rotation 211 of the photoreceptor 21 and the extension of the straight line L1 connecting the center of rotation 622 of the brush supporting member 612 and the center of rotation 714 of the rotating shaft 711 becomes, for example, 90° or more but less than 180°, preferably, 90° or more but less than 150°.

Because of setting the angle θ3 in this manner, even when the lubricant supplying device 5 is placed by the side of the photoreceptor 21, since the large particles K_{L}, that were not conveyed to the photoreceptor 21 fall to inside the lubricant supplying apparatus 5 along the inclined lubricant supplying casing 8, they do not get close again to the photoreceptor 21, and only the small particles Ks can get adhered to the photoreceptor 21.

Further, instead of the lubricant storing member 631 that supplies a solid lubricant K1 in FIGS. 4a to 4c, it goes without saying that a lubricant storing member 631′ that supplies a powdered lubricant K2 explained with reference to FIG. 2b can be provided.

Further, it goes without saying that the lubricant supplying device 5 shown in FIGS. 4a-4c can also be used suitably in a monochromatic image forming apparatus.

The operations related to supplying of the lubricant by the lubricant supplying device 5 described above are programmed to be stored in a memory section not shown in the figure, and the operations are executed by the control section C by reading out said programs from the memory section, and by carrying out the drive control of the respective members.

In the following, regarding the image blur and streaking defect that were the problems in the background technology, since we carried out comparison evaluation of the effects of the lubricant supplying devices of the background technology and the lubricant supplying device of the present invention, the results are explained referring to Table 1 and Table 2 given below.

The evaluation was made using an image forming apparatus A described referring to FIG. 1, and the output images were evaluated by carrying out image formation after incorporating the lubricant supplying devices 5 explained referring to FIGS. 4a-4c into the image forming apparatus A as the implementation examples. In addition, as the comparison examples, the output images were evaluated by carrying out image formation after incorporating the lubricant supplying devices 5 shown in FIGS. 5a and 5b.

FIGS. 5a and 5b are diagrams of the lubricant supplying devices used in the comparison examples.

FIG. 5a is the lubricant supplying device used in the Comparison Example 1, and FIG. 5b is the lubricant supplying device used in the Comparison Example 2.

In FIGS. 5a and 5b, the lubricant supplying device 5′ does not have a conveying section 7 described above, but has a brush supporting member 612′, a contacting member 62′ whose tip comes in contact with the brush 611′ that have been planted on the brush supporting member 612′, a lubricant supplying casing 8′ that houses all these, and a lubricant storing member 631′ that stores a solid lubricant K1.

Further, since the brush supporting member 612′ and the brush 611′ have constructions similar to those described referring to FIGS. 2a and 2b their detailed descriptions will be omitted.

The placement is made so that the tip of the brush 611′ and the photoreceptor 21 are opposed to each other and are separated from each other by about 1 mm, and the brush supporting member 612′ is driven rotationally in the direction of the arrow at a rotational speed of 550 rpm by a driving section not shown in the figure.

Further, the surface of the solid lubricant K1 is scraped by the rotating brush 611′, the solid lubricant K1 is pulverized into lubricant particles Kr, which are then made to get adhered to the brush 611′, and subsequently by flicking the brush 611′ by the contacting member 62′, the lubricant particles Kr are conveyed directly to the photoreceptor 21 and adhered to it.

In FIG. 5a, the contacting member 62′ is electrically grounded.

Then, the lubricant particles Kr that are adhered to the brush 611′ that has been put at zero electric potential are flicked by the contacting member 62′, are made to fly off by the centrifugal force of the brush 611′, and are made to directly adhere to the photoreceptor 21.

In FIG. 5b, the contacting member 62′ is connected to a DC power source 65, and a DC bias voltage (−200 V) is being applied to it from the DC power source 65.

Further, the lubricant particles Kr adhered to the brush 611′ that has been put at a negative electric potential are flicked by the contacting member 62′, are made to fly off by the centrifugal force of the rotating brush 611′, and are made to directly adhere to the photoreceptor 21.

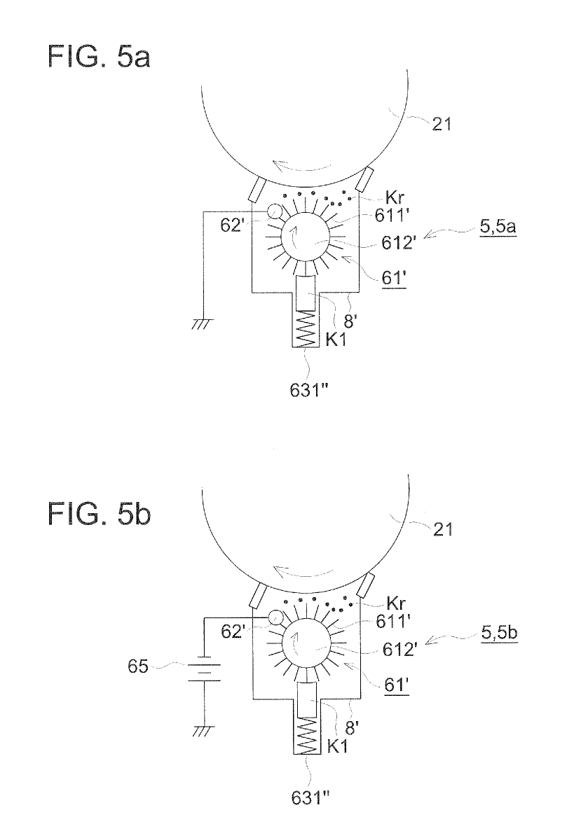

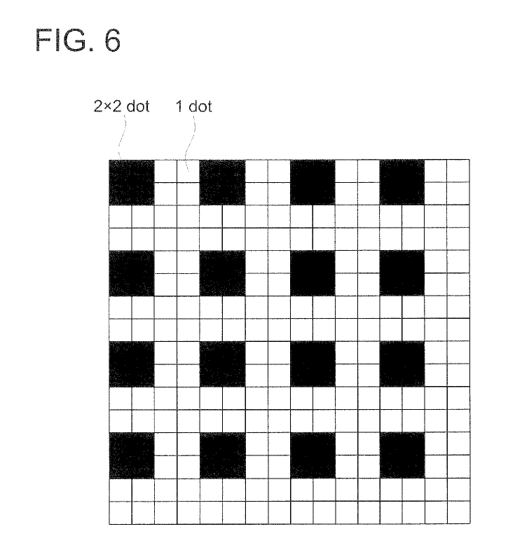

Table 1 shows the evaluation of mainly image blur, where the dot hatching image constituted by 2×2 dots (1200 dpi) shown in FIG. 6 was output, the granularity of this dot hatched region was checked visually, and the result was taken as “A” when there was no unevenness such as roughness, etc., and the result was taken as “B” when there was unevenness with some conspicuous roughness.

Further, In FIG. 6, one square indicates one dot, and a halftone image is formed by repeating alternately a black point consisting of 4 dots and a blank space consisting of 4 dots in both vertically and horizontally.

Further, a 5-point (1200 dpi) high resolution text character image of is output, and the result was taken as “A” when all characters could be clearly identified by visual inspection, and the result was taken as “B” when at least one character could not be identified due to an image blur.

TABLE 1

| | | Comparison | Comparison |
|---|---|---|---|
| Evaluated item | Example 1 | Example 1 | Example 2 |
| Granularity of 2 × 2 dots area | A | B | B |
| Reproducibility of 5-point | A | B | B |
| characters | | | |

Table 2 shows the evaluation of mainly streak defects, where multiple sheets of an image with a print ratio of 10% were output continuously, and the presence or absence of streak defects where a streak is generated in the output image were checked visually, and the result was taken as “A” when there are no streaks in the white background part, and the result was taken as “B” when some streak was present.

TABLE 2

| Number of sheets printed | | Comparison | Comparison |
|---|---|---|---|
| (Unit: thousand sheets) | Example 1 | Example 1 | Example 2 |
| 1 | A | A | A |
| 10 | A | A | A |
| 50 | A | A | A |
| 100 | A | B | B |
| 300 | A | B | B |

As a result, as is shown in Table 1, the granularity is good in the 2×2 dot regions in the implementation example, no unevenness could be seen in the halftone images, and even the reproducibility of the 5-point (1200 dpi) high resolution text characters was good with the characters being clearly identifiable.

However, in the Comparison Example 1 and Comparison Example 2, the granularity of the 2×2 dot areas was poor, unevenness was observed in the halftone images, and even the reproducibility of the 5-point (1200 dpi) high resolution text characters was bad and there were characters that could not be identified.

Further, as is shown in Table 2, streak defects did not occur in the Implementation Examples even after printing 300,000 sheets.

However, in the Comparison Example 1 and Comparison Example 2, streak defects occurred at 100,000 sheets and beyond.

As explained above, in a lubricant supplying apparatus of the present invention, it was confirmed that there were no blurs in the images, that the 5-point (1200 dpi) high resolution text characters could be definitely identified, that there were also no unevenness in the images, and that streak defects did not occur even after outputting 300,000 sheets.

As has been explained above, by providing a cloud generating section 6 and a conveying section 7, generating a cloud of lubricant particles mixed with air in the cloud generating section, generating a circulating air current AC that is uniform and also has a prescribed air flow speed by the conveying section 7 and selecting the small particles from the lubricant particles due to the classifying effect by said circulating air current, and by making the selected small particles Ks get adhered to the image carrier, a lubricant layer can be applied on the image carrier uniformly and thinly.

Further, because of this, it has become possible to provide a lubricant supplying device that enables to output high quality images without image blurs, image unevenness, or streak defects, and to provide an image forming apparatus having such a lubricant supplying device.

### Second Preferred Embodiment

The following describes the second embodiment of the present invention with reference to the drawings. However, the embodiment of the invention is not limited to this.

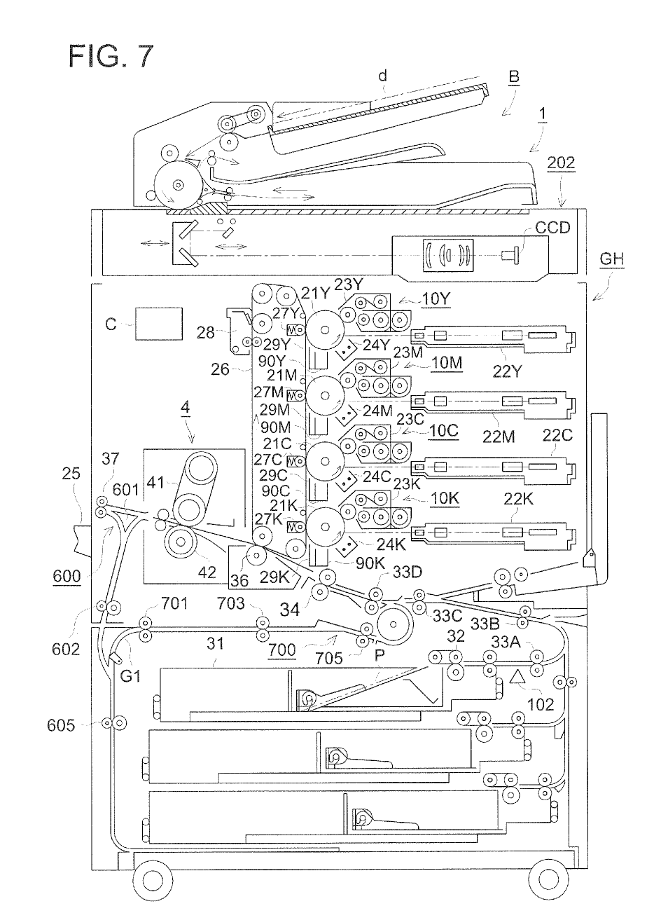

In the first place, an example of the image forming apparatus relating to the present invention will be described with reference to FIG. 7.

This image forming apparatus includes an image forming apparatus main unit GH and an image reading device 1. The image forming apparatus main unit GH is called the tandem color image forming apparatus, and includes a plurality of image forming sections 10Y, 10M, 10C and 10K, belt-shaped intermediate transfer belt 26, sheet feed and conveying unit and fixing device 4, reverse sheet ejection section 600, and a ADU (Auto Duplex Unit) 700 for reverse conveyance.

Further, the image forming apparatus includes control section C for controlling each part.

The top of the image forming apparatus main unit GH is provided with the image reading device 1 including an automatic document feed device B and document image scanning exposure device 202. The document “d” placed on the document platen of the automatic document feed device B is conveyed by the conveying unit. The image on one or both surfaces of the document is subjected to scanning and exposure by the optical system of the document image scanning exposure device 202, and is read into the line image sensor CCD.

The signal formed by photoelectric conversion through the line image sensor CCD is subjected to analog processing, analog-to-digital conversion, shading correction and image compression in the image processing section, and is sent to the exposure sections 22Y, 22M, 22C and 22K

The image forming sections 10Y forming a yellow (Y) image has a charging section 24Y, exposure section 22Y, development section 23Y, cleaning section 29Y and lubricant supplying device 90Y arranged around the photoreceptor drum 21Y which is an image carrier. The image forming sections 10M forming a magenta (M) image has a charging section 24M, exposure section 22M, development section 23M, cleaning section 29M and lubricant supplying device 90M arranged around the photoreceptor drum 21M which is an image carrier. The image forming sections 10C forming a cyan (C) image has a charging section 24C, exposure section 22C, development section 23C, cleaning section 29C and lubricant supplying device 90C arranged around the photoreceptor drum 21C which is an image carrier. The image forming sections 10K forming a black (K) image has a charging section 24K, exposure section 22K, development section 23K, cleaning section 29K and lubricant supplying device 90K arranged around the photoreceptor drum 21K which is an image carrier. Latent image forming sections are formed by a charging section 24Y and exposure section 22Y, a charging section 24M and exposure section 22M, a charging section 24C and exposure device 22C, and a charging section 24K and exposure section 22K.

The development sections 23Y, 23M, 23C and 23K includes the two-component developer made of yellow (Y), magenta (M), cyan (C) and black (K) toners having a small particle diameter, and carriers respectively. The toner is made of pigment or dye serving as a coloring reagent, a wax helping separation of toner from the fixing member after fixing, and a binder resin for holding them together.

The intermediate transfer belt 26 is wound around a plurality of rollers and is supported rotatably.

The fixing device 4 allows the toner image of the sheet P to be heated and pressed by the nip portion formed between a fixing belt 41 as a heated fixing member and pressure roller 42, as pressure member whereby the toner image is fixed in position.

Thus, images of respective colors formed by the image forming sections 10Y, 10M, 10C and 10K are sequentially transferred onto the rotating intermediate transfer belt 26 by the transfer units 27Y, 27M, 27C and 27K (primary transfer), and a composite color toner image is created.

After transferring the toner image onto the intermediate image transfer member 26, cleaning of the toner remaining on each of the photoreceptor drums (21Y, 21M, 21C, and 21K) is done by their respective cleaning sections (29Y, 29M, 29C, and 29K).

Each of the cleaning sections (29Y, 29M, 29C, and 29K) is provided with a cleaning blade 291 that comes in contact with their respective photoreceptor drums (21Y, 21M, 21C, and 21K) and wipes off the adhered toner. A plastic such as nylon, polyester, acrylic is used preferably as the cleaning blade 291.

The paper P stored inside a sheet feeding cassette 31 is fed out by a sheet feeding device 32, is passed through the sheet feeding rollers 33A, 33B, and 33C, the loop forming roller 33D, the registration roller 34, etc., is conveyed to the image transfer device 36, and a color image is transferred onto the paper P (secondary transfer).

The loop forming roller 33D and the registration roller 34 correct a skew and offset of the paper P.

The paper P onto which a color image has been transferred is subjected to heat and pressure in the fixing device 4 and the color toner image on the paper P is fixed. After that, the paper P is gripped and conveyed by the sheet discharge rollers 37 and placed on the sheet discharge tray 25 outside the apparatus.

Further, by changing the position of the path switching member 601 of the reverse sheet discharging section 600, the sheet can also be discharged by reversing the first surface and the second surface of the paper P.

For example, during reverse discharge of the paper P, the position of the path switching member 601 is changed so that the paper P is guided downward along the right side of the path switching member 601, and the paper P is conveyed in the direction of the roller pair 602. Next, after the paper is in the condition in which its rear end is being gripped by the roller pair 602, the roller pair 602 is rotated in the opposite direction, and the paper P is raised upward. After that, the paper P passes through the left side of the path switching member 601 and reaches said sheet discharge roller 37, and it is gripped and conveyed by the sheet discharge rollers 37 and placed on the sheet discharge tray 25 outside the apparatus.

Further, in the case of the double sided printing mode using the ADU 700, the paper P after image formation on its first surface and a fixing process is guided downwards along the right side of the path switching member 601, and the conveying is stopped in the condition in which the rear end of the paper P has been gripped by the roller pair 605.

Next, the roller pair 605 rotates in the opposite direction, the sheet P is made to rise upward along the guide plate G1, and the reverse of the paper is carried out by guiding it to the ADU 700 which has a plurality of roller pairs 701, 703, and 705.

On the other hand, after a color image has been transferred onto the paper P by the image transfer means 36, the remaining toner on the intermediate image transfer belt 26 from which the paper P has been separated using curvature is cleaned by a cleaning section 28.

Further, although the above apparatus was an image forming apparatus forming color images, this can also be a monochromatic image forming apparatus, and an intermediate image transfer belt may or may not be used.

In addition, the fixing device 4 can also be a heated roller type fixing device having a roller provided with a heating device in the fixing member.

Here, as has been explained above, after the toner image has been transferred onto the intermediate image transfer belt 26, cleaning of the toner remaining on the photoreceptor drum 21Y is done by a cleaning blade 291 of a cleaning section 29Y, and the toner remaining after transfer is removed.

In order to enhance the cleaning performance of this cleaning blade 291 or the image transferring performance, and also in order to reduce the wear on the surface of the photoreceptor drum 21Y or cleaning blade 291, supplying and coating of a lubricant are done on the surface of the photoreceptor drum 21Y.

The lubricant supplying device 90Y is used for this supplying and coating of a lubricant. Next, descriptions are given about the lubricant supplying devices (90Y, 90M, 90C, and 90K) that carries out this lubricant supplying and coating. Since the constructions of all of these lubricant supplying devices are the same, the descriptions are given taking the example of the lubricant supplying device 90Y which is placed in the image forming section 10Y.

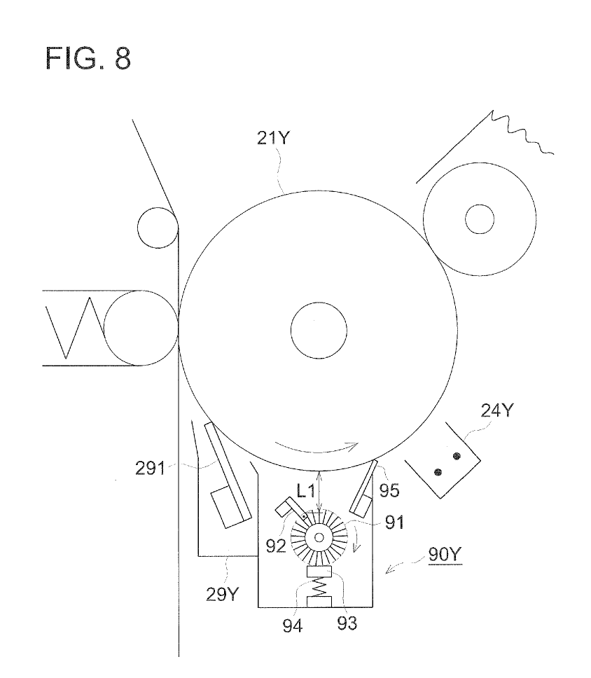

FIG. 8 is a diagram showing a preferred embodiment of a lubricant supplying device 90Y and a photoreceptor 21Y.

The lubricant supplying device 90Y is placed on the downstream side of the cleaning section 29Y and also on the upstream side of the charging section 24Y in the direction of rotation of said photoreceptor drum 21Y.

The lubricant supplying device 90Y has a brush 91 which is a lubricant supplying member and is supported in a rotatable manner, a flicker 92 which is a contacting member that comes in contact with the brush 91, a leveling blade 95 which is a leveling member that comes in contact with the photoreceptor drum 21Y, a solid lubricant 93, and a spring 94 that pushes the solid lubricant 93 toward the brush 91.

The brush 91 is provided in a rotatable manner at a position where the bush 91 is opposed to the photoreceptor drum 21Y without contacting it. Fiber-shaped brush bristles have been provided on the circumference of the brush 91. A material having flexibility and electrical conductivity, for example an electrically conductive fiber such as a plastic fiber in which an electrical conductivity adding material such as carbon or the like is mixed, is used for the brush bristles. For example, acrylic carbon fiber can be given as an example of this electrically conductive fiber.

The solid lubricant 93 is in contact with the brush 91 by being pushed by the spring 94. When the brush 91 rotates in the direction of the arrow in FIG. 8 due to being driven by a driving device (not shown in the figure), it scrapes off the solid lubricant 93 and makes it into a lubricant in the form of a powder. Hereinafter, unless otherwise specified, the term “lubricant” refers to this lubricant in the powder form. This lubricant gets adhered to the surface of the brush bristles and is held on the brush 91.

The flicker 92 is placed on the upstream side, in the direction of rotation of the brush 91, of the position where the brush 91 and the photoreceptor drum 21Y are opposed to each other, and also on the downstream side of the contact position with the solid lubricant 93. In addition, the flicker 92 is a plate shaped member, and is positioned so that it invades into the bristles toward the center of rotation of the brush 91.

Because of this configuration, after the bristles of the brush 91 are bent at the position of the flicker 92 toward the upstream side in the direction of rotation of the brush 91, they forcefully return to their original shape (stand straight) when they have slipped through the position of the flicker 92. At the time that the brush bristles return their original shape, a force is generated which causes the lubricant held by the brush 91 to fly off. Because of this, the lubricant held by the brush 91 is flown off and the space between the brush 91 and the photoreceptor drum 21Y will be filled with the lubricant that has gone into the powder form. This lubricant in the powder form is supplied to the photoreceptor drum 21Y.

The leveling blade 95 levels the lubricant supplied and then adhered to the photoreceptor drum 21Y into a thin layer. Because of this, the photoreceptor drum 21Y is coated with the lubricant. As the material of the leveling blade 95, polyurethane rubber, silicone rubber, nitrile rubber, chloroprene rubber, or the like can be used.

In the coating of this lubricant, if there is unevenness in the coating and the coating becomes non-uniform, it becomes easy for local differences to appear in the width of the wear of the cleaning blade, and the durability decreases. Cleaning defects become a cause for image defects such as image streaks, or the like. Because of this, during the coating of the lubricant, it is required to apply the lubricant uniformly on the surface of the image carrier. In addition, if the applied quantity of the lubricant becomes too much, then it becomes easy for undulations to appear on the surface of the lubricant, causing the problem to occur that wear of the cleaning blade is promoted. It is therefore required to coat thinly in addition to uniformly.

However, the lubricant that the brush 91 scrapes off from the solid lubricant 93 and holds, in most cases, will have variations in the size of the individual lubricant particles (particle diameter).

Here, in the present invention, the particle diameter is the maximum diameter of the individual particles of the lubricant.

Because the particle diameter of the lubricant fluctuates as described above, when large diameter and small diameter lubricants are mixed and get adhered to the photoreceptor drum 21Y, the unevenness of the adhered lubricant layer becomes large, and it was difficult to form a uniform and thin coating layer of the lubricant even if a leveling blade 95 is used.

In order to reduce these undulations and form a uniform and thin lubricant coating layer, it is desirable that lubricant particles with less than or equal to a prescribed particle size are supplied to and adhered to the photoreceptor drum 21Y.

Because of this, in the lubricant supplying device 90Y of the present invention, the flicker 92 is placed so that the reaching range of the lubricant flying in the direction of the photoreceptor drum 21Y becomes longer for the small diameter lubricant particles than for the larger diameter lubricant particles because of the effect of gravity, that is, so that a different distribution is obtained depending on the particle diameter of the lubricant.

In addition, the placement is done at a position so that only the particles with less than or equal to a prescribed particle diameter reach and get adhered to the photoreceptor drum 21Y. In other words, the placement is done such that, the distance L1 (see FIG. 8) from the flicker 92 to the photoreceptor drum 21Y is longer than the distance to the position which the lubricant particles with more than the prescribed particle diameter fly to reach due to the energy of the force applied to that lubricant particle when a brush bristle detaches from the flicker 92.

In addition, the brush 91 is placed at a position so that even when the lubricant particle held by the brush falls freely, it does not fall on the photoreceptor drum 21Y.

In the present preferred embodiment, the brush 91 and the flicker 92 are placed almost directly below the photoreceptor drum 21Y. Because of this, the arrival at and adhesion to the photoreceptor drum 21Y of the lubricant particles exceeding a prescribed particle diameter can be suppressed. However, an ignorable small quantity of lubricant particles exceeding the prescribed particle diameter can also get adhered.

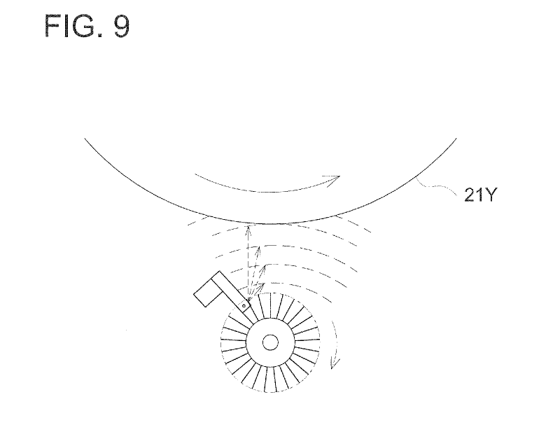

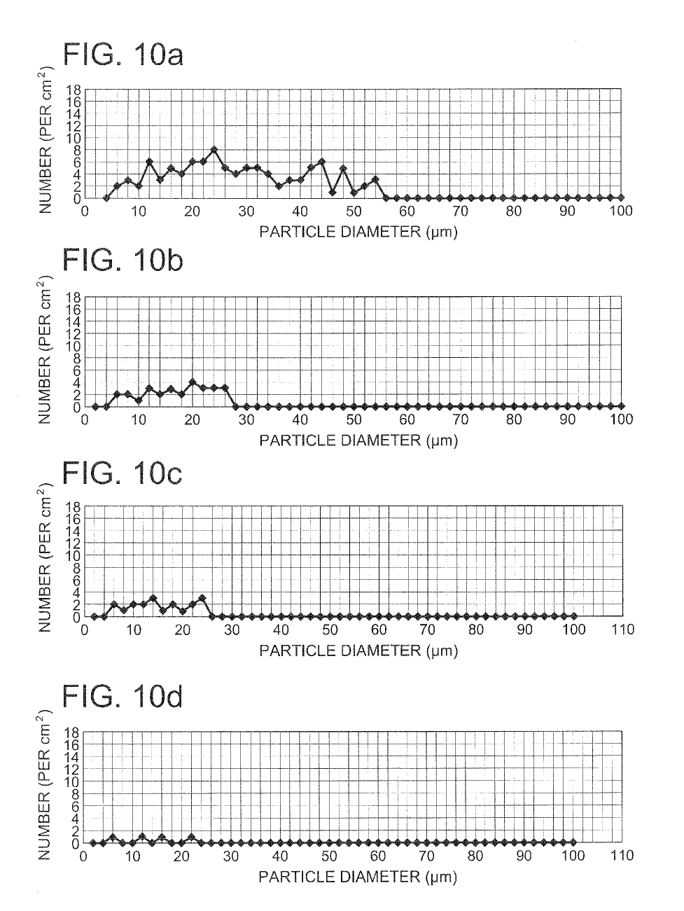

FIG. 9 is a schematic diagram expressing the flying of the lubricant particles. The broken lines in the figure express the distance of flight of lubricant particles that differs depending on the particle diameter. As has been explained earlier, the brush 91 and the flicker 92 have been placed so that only the lubricant particles with less than or equal to a prescribed particle diameter arrive at and get adhered to the photoreceptor drum 21Y.

The lubricant that has gotten adhered to the photoreceptor drum 21Y is further leveled by the leveling blade 95, and made into a thin layer. The lubricant is supplied and applied in this manner.

This prescribed particle diameter is set by estimating based on experiments in similar existing lubricant supplying devices and data on past performance considering the thickness of the lubricant film formed on the photoreceptor drum 21Y, the ease of leveling the lubricant that has gotten adhered to the photoreceptor drum 21Y by the leveling blade 95, the replacement period of the cleaning blade 291 specified in the specifications of that apparatus model, etc., and in addition further based on experiments with the actual device.

In this manner, by arranging the photoreceptor drum 21Y, the brush 91, and the flicker 92 so that only the particles with particle diameters less than or equal to the prescribed particle diameter get adhered to the surface of the photoreceptor drum 21Y, it becomes possible to apply the lubricant thinly and uniformly on the surface of the photoreceptor drum 21Y.

Because of this, it becomes possible to aim at increasing the life of the cleaning blade 291.

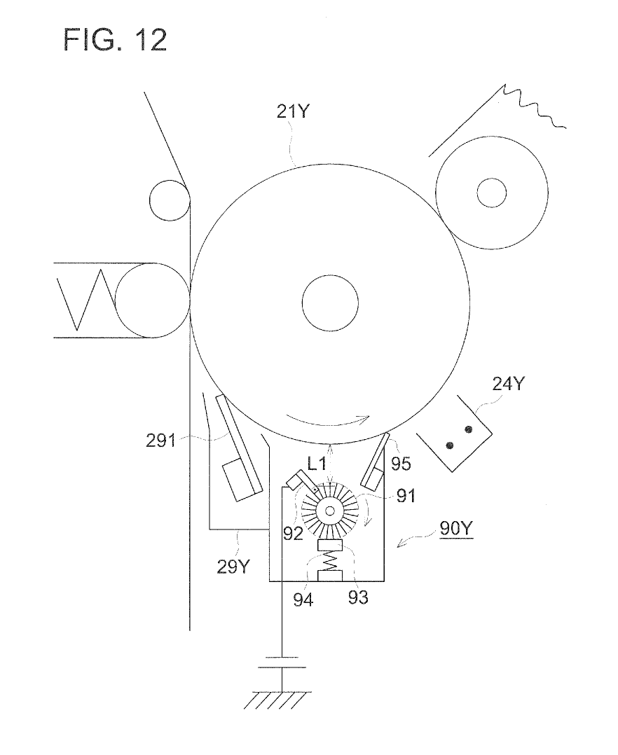

FIG. 12 shows the example when a bias voltage is applied to the flicker 92 in the embodiment (Implementation Example 1) shown in FIG. 8 and an electric field is created between the photoreceptor drum 21Y and the flicker 92 (Implementation Example 2). In the Implementation Example 2, this bias voltage is set to −200 V.

Here, in the Implementation Example 2, the bias voltage has been set so that the lubricant that has flown off by the flicker 92 receives a force in a direction opposite to that of the photoreceptor drum 21Y (the downward direction in FIG. 12). Therefore, the reaching range in the direction of the photoreceptor drum 21Y of the lubricant that has flown off by the flicker 92 becomes smaller than in the Implementation Example 1 due to the effect of the bias voltage in addition to the effect of gravity.

In a case such as this, the lubricant that is in the powdered form is more easily affected by the application of the bias voltage as its particle diameter becomes larger. Because of this, the difference between the reaching range in this case and the reaching range in the Implementation Example 1 becomes larger in the case of lubricant particles with larger particle diameters than in the case of lubricant particles with smaller diameters. In other words, the reaching range of the larger particles becomes further smaller compared to that of the smaller particles.

Therefore, compared to the Implementation Example 1, even if the distance between the brush 91 and the photoreceptor drum 21Y is made small, the arrival at and adhesion to the photoreceptor drum 21Y of lubricant particles exceeding the prescribed particle diameter can be suppressed. In addition, the space between the brush 91 and the photoreceptor drum 21Y can be filled with more lubricant in the powder form than in the Implementation Example 1.

Because of this, it becomes possible to apply the lubricant thinly and uniformly on the surface of the photoreceptor drum 21Y. In addition, in the Implementation Example 2 compared to the Implementation Example 1, it is possible to aim at increasing the life of the cleaning blade 291 and reducing the space requirement of the apparatus.

Next, the evaluation of the Implementation Example 1 and the Implementation Example 2 is explained.

The prescribed particle diameter of the lubricant in this apparatus model was set by estimation to about 25 to 26 μm based on the specifications of the apparatus model, experiments and actual performance data of a similar existing lubricant supplying device as explained earlier.

### Implementation Example 1

In an image forming apparatus provided with the lubricant supplying device 90 (Y, M, C, and K) shown in FIG. 8, the lubricant was applied on the photoreceptor drum 21 (Y, M, C, and K), printing was made, and the durability of the cleaning blade 291 was evaluated.

<Evaluation Specifications>

Process speed: 315 mm/s

Two-component development method

Developer: average carrier particle diameter of 33 μm, average toner particle diameter of 6.5 μm

Lubricant: material ZnSt (solid zinc stearate), size: 8 mm×8 mm×330 mm

Photoreceptor drum: external diameter φ60 mm, photoreceptor film thickness of 30 μm

Brush: external diameter φ12 mm
Brush bristle material: acrylic carbon
Brush bristle diameter: 3 deniers
Brush bristle density: 150,000 bristles/inch² (=150 kF/inch²)
Brush bristle length: 2.75 mm
Amount of invasion of the flicker: 1.0 mm
Brush surface speed: 126 mm/s

Flicker: material: stainless steel

Pushing force on the lubricant: 0.64 N

Brush position: directly below the photoreceptor

<Method of Evaluation>

The distance L1 (see FIG. 8) between the flicker 92 and the photoreceptor drum 21Y was varied, and the number of sheets printed out until a cleaning defect occurred and streaks appeared in the printed out image was evaluated.

As the Example 1-1, the distance L1 was set equal to 10 mm so that lubricant particles exceeding the prescribed particle diameter of 26 μm set in the Implementation Example 1 do not arrive at the photoreceptor drum 21Y.

As the Example 1-2 and the Comparison Example 1-2, the distance L1 of the Example 1-1 was set successively longer, and even the number of lubricant particles whose diameters are smaller than the prescribed particle diameter and have gotten adhered were successively reduced. The distance L1 was set equal to 25 mm in the Example 1-2, and the distance L1 was set equal to 30 mm in the Comparison Example 1-2.

As the Comparison Example 1-1, the distance L1 was set equal to 5 mm so that the lubricant particles whose diameters exceed the prescribed particle diameter would arrive at the photoreceptor drum 21Y.

<Results>

Each of FIGS. 10a-10d is a graph showing the particle diameter distributions of the lubricant that has gotten adhered to the photoreceptor drum 21Y. FIG. 10a is for the Example 1-1 (L=5 mm), FIG. 10b is for the Example 1-1 (L=10 min), FIG. 10c is for the Example 1-2 (L=25 mm), and FIG. 10d is for the Example 1-2 (L=30 mm). The summation was done for lubricant particle diameters of every 2 μm.

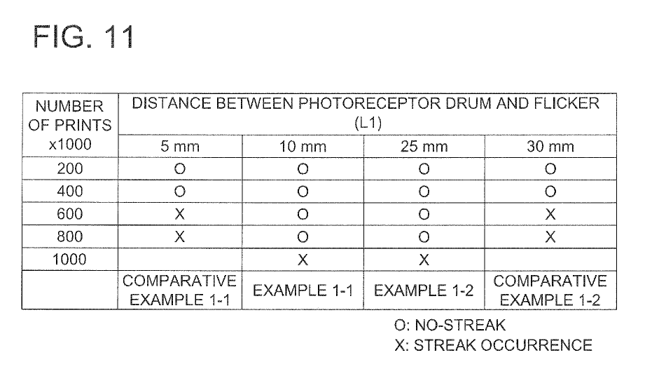

FIG. 11 is a table diagram showing the results of evaluation. In the Examples 1-1 and 1-2, streaks did not appear in the image due to cleaning defects until 800,000 sheets were printed. When the width of wear of the cleaning blade 291 was measured at the time that 800,000 sheets had been printed, the variation in wear in the axial direction was small compared to the Comparison Example 1-1 and the Comparison Example 1-2. This is because, since the lubricant particles mainly having particle diameters not exceeding the prescribed particle diameter got adhered to the photoreceptor drum 21Y, and also since it was possible to secure the amount of adhered lubricant which does not make coating uneven, a coating layer of the lubricant which was a uniform and thin film on the surface of the photoreceptor dram 21Y could be formed. As a result, the life of the cleaning blade became longer.

In the Comparison Example 1-1, although streaks did not appear in the image due to cleaning defect until 400,000 sheets were printed, streaks in the image were recognized markedly at the time that 600,000 sheets had been printed. The printing was continued further, and when the width of wear of the cleaning blade 291 was measured at the time that 800,000 sheets had been printed, the variation in wear in the axial direction was large compared to the Example 1-1 and the Example 1-2. This is because, as has been shown in FIG. 10a, FIG. 10b, and FIG. 10c, in the Comparison Example 1-1, since even the lubricant particles exceeding the prescribed particle diameter of 26 μm did get adhered to the surface of the photoreceptor drum 21Y in large numbers, larger unevenness occurred in the lubricant layer adhered to the surface of the photoreceptor drum 21Y than in the Example 1-1 and the Example 1-2, and even after leveling by the leveling blade 95, it was difficult to make the lubricant coating layer a uniform and thin film. Due to this unevenness, the variation in the wear of the cleaning blade 291 became large, and as a consequence the life became short.

In the Comparison Example 1-2, although streaks did not appear in the image due to cleaning defects until 400,000 sheets were printed, streaks in the image were recognized markedly at the time that 600,000 sheets had been printed. The printing was continued further, and when the width of wear of the cleaning blade 291 was measured at the time that 800,000 sheets had been printed, the variation in wear in the axial direction was large compared to the Example 1-1 and the Example 1-2. This is because, although the lubricant particles that got adhered to the photoreceptor drum 21Y were mainly those having less than the prescribed particle diameter, since the distance L1 was large, it was difficult to obtain the adhesion of sufficient lubricant particles for forming a uniform layer of the lubricant compared to the Example 1-1 and the Example 1-2. In other words, variation in the film thickness occurred on a thin lubricant layer and in parts where a lubricant layer could not be formed, and undulations occurred due to that in the lubricant coating layer, the variation in the wear of the cleaning blade 291 became large, and as a consequence the life became short.

As is indicated by the above results, the effects of the present invention were confirmed.

### Implementation Example 2

In an image forming apparatus provided with the lubricant supplying device 90 (Y, M, C, and K) shown in FIG. 12, the lubricant was applied on the photoreceptor drum 21 (Y, M, C, and K), printing was carried out and the durability of the cleaning blade 291 was evaluated.

The specifications for evaluation and the method of evaluation were according to the Implementation Example 1 excepting the application of the bias voltage.

<Method of Evaluation>

The distance L1 (see FIG. 12) between the flicker 92 and the photoreceptor drum 21Y was varied, and the number of sheets printed out until a cleaning defect occurred and streaks appeared in the printed out image was evaluated.

As the Example 2-1, the distance L1 was set equal to 10 mm so that lubricant particles exceeding the prescribed particle diameter of 26 μm set in the Implementation Example 2 do not arrive at the photoreceptor drum 21Y.

As the Comparison Example 2-1, the distance L1 was set equal to 5 mm so that the lubricant particles exceeding the prescribed particle diameter arrive at the photoreceptor drum 21Y.

<Results>

Each of FIGS. 13a and 13b is a graph showing the particle diameter distributions of the lubricant that has got adhered to the photoreceptor drum 21Y. FIG. 13a is for the Comparison Example 2-1 (L1=5 mm), and FIG. 13b is for the Example 2-1 (L1=10 mm). The summation was done for lubricant particle diameters of every 2 μm.

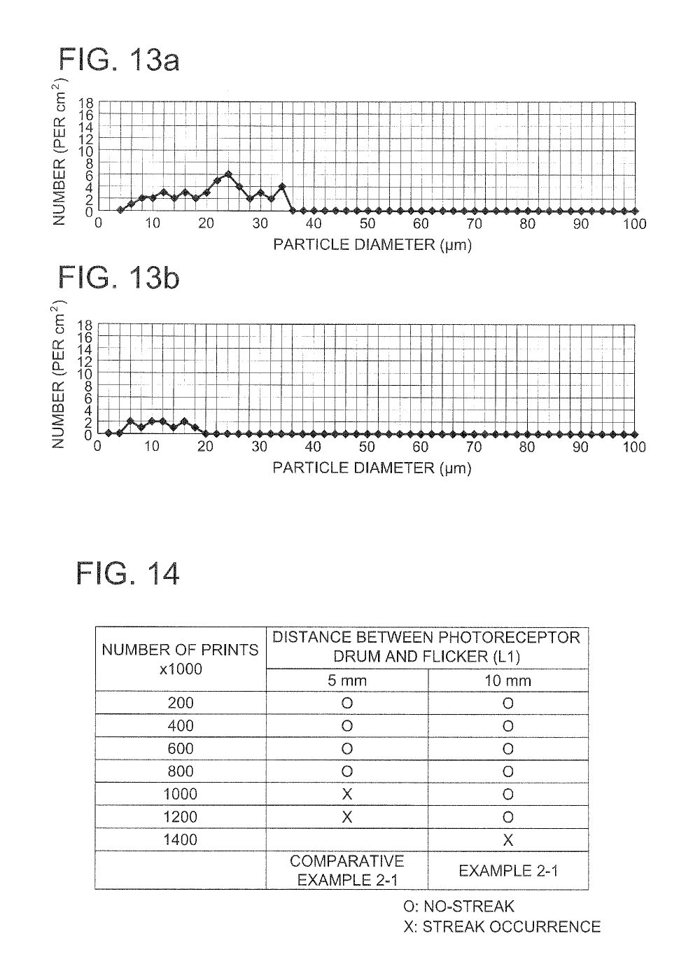

FIG. 14 is a table diagram showing the results of evaluation.

In the Example 2-1, streaks did not appear in the image due to cleaning defects until 1,200,000 sheets were printed. When the width of wear of the cleaning blade 291 was measured at the time that 1,200,000 sheets had been printed, the variation in wear in the axial direction was small compared to the Comparison Example 2-1. This is because, since the lubricant particles having particle diameters not exceeding the prescribed particle diameter got adhered to the photoreceptor drum 21Y, and also since it was also possible to acquire the amount of their adhesion to ensure that no coating unevenness is generated, it was possible to form a coating layer of the lubricant which was a uniform and thin film on the surface of the photoreceptor drum 21Y. As a result, the life of the cleaning blade 291 became longer.

As has been explained above, it is possible to fill the space between the brush 91 and the photoreceptor 21Y with a lubricant in the powder form more than in the Implementation Example 1. Because of this, in the Example 2-1, compared to the Examples 1-1 and 1-2, a better uniform and thin film of coating layer of the lubricant can be formed on the surface of the photoreceptor drum 21Y. As a result, the life of the cleaning blade 291 became longer. Because of this, from the above, as is shown in FIG. 11 and FIG. 14, further improvement could be achieved in the Implementation Example 2 compared to the Implementation Example 1.

In the Comparison Example 2-1, although streaks did not appear in the image due to cleaning defects until 800,000 sheets were printed, streaks in the image were recognized markedly at the time that 1,000,000 sheets had been printed. The printing was continued further, and when the width of wear of the cleaning blade 291 was measured at the time that 1,200,000 sheets had been printed, the variation in wear in the axial direction was large compared to the Example 2-1. This is because, since even the lubricant particles having more than the prescribed particle diameter had gotten adhered to the photoreceptor drum 21Y in large numbers, undulations larger than in the Example 2-1 occurred in the layer of lubricant adhered on the surface of the photoreceptor drum 21Y, and even after leveling by the leveling blade 95, it is difficult to make the lubricant coating layer a uniform and thin film. Due to this unevenness, the variation in the wear of the cleaning blade 291 became large, and as a consequence the life became short.

The reason why the difference from the Comparison Example 2-1 occurred is the same as in the case of the Example 1-1.

As indicated by the above results, the effects of the embodiment of the present invention were confirmed.

From the above, it becomes possible to apply a lubricant thinly and uniformly on the surface of an image carrier. Because of this, the durability of the cleaning blade can be increased, and the suppression of image deterioration due to the wear of the cleaning blade can be enhanced.

What is claimed is:

1. A lubricant supplying system comprising:
an image carrier; and
a lubricant supplying device for supplying a lubricant to a surface of the image carrier, the lubricant supplying device comprising:
a cloud generating section which generates a cloud in which particles of the lubricant are mixed with air, and
a conveying section which classifies the particles of the lubricant present in the cloud which is generated in the cloud generating section into small particles of less than a prescribed size and large particles of more than or equal to the prescribed size, and conveys the classified small particles toward the image carrier.

2. The lubricant supplying system of claim 1,
wherein the cloud generating section, the conveying section, and the image carrier are arranged mutually separated from one another, and the cloud generating section, the conveying section, and the image carrier are arranged in this order in a direction of movement of the particles of the lubricant.

3. The lubricant supplying system of claim 1,
wherein the conveying section comprises:
an air current generating section which generates an air current at least a part of which flows toward the image carrier.

4. The lubricant supplying system of claim 3,
wherein the air current generating section comprises:
a plurality of blade members;
a blade supporting member which supports the blade members rotatably; and
a mutation driving member which rotates the blade supporting member at a prescribed constant mutational speed.

5. The lubricant supplying system of claim 4,
wherein the air current is a circulating air current which circulates in surroundings of the blade members, and at least a part of the circulating air current is flown toward the image carrier.

6. The lubricant supplying system of claim 3,
wherein the air current generating section generates the air current with an air velocity which ensures that the particles of the lubricant present in the cloud are classified into the small particles and the large particles and the classified small particles can be conveyed up to the image carrier and the classified large particles cannot be conveyed up to the image carrier.

7. The lubricant supplying system of claim 1,
wherein the cloud generating section comprises:
a plurality of elastic members;
a contacting member which comes in contact with tip sections of the elastic members;
a supporting member which supports the elastic members and enables the elastic members to move relative to the contacting member; and
a lubricant storage section which stores the lubricant and supplies the stored lubricant to the elastic members,
wherein the contacting member is arranged on a downstream side in a direction of movement of the elastic members with respect to the lubricant storage section.

8. The lubricant supplying system of claim 7,
wherein the supporting member is a rotating member which is configured to rotate, and the elastic members are arranged racially at uniform intervals on a peripheral surface of the rotating member and forms a brush having elasticity.

9. The lubricant supplying system of claim 8 further comprising:
a brush driving member which rotates the brush via the rotating member at a prescribed constant rotational speed.

10. The lubricant supplying system of claim 1 further comprising:
a casing for housing the cloud generating section and the conveying section; and
a lubricant sealing member which is arranged on a side of the easing which is opposed to the image carrier and prevents leaking of the particles of the lubricant to an outside of the casing,
wherein one end of the lubricant sealing member is fixed to the easing and another end is allowed to be in contact with the image carrier.

11. The lubricant supplying system of claim 1,
wherein the image carrier is a photoreceptor.

12. The lubricant supplying system of claim 11, further comprising:
a cleaning section which cleans a developer remaining on the photoreceptor; and
a charging section which uniformly charges the photoreceptor,
wherein the lubricant supplying device is arranged on a downstream side of the cleaning section and on an upstream side of the charging section in a direction of rotation of the photoreceptor.

13. The lubricant supplying system of claim 1,
wherein the image carrier is an intermediate image transfer member.

14. The lubricant supplying system of claim 13, further comprising:
a cleaning section which cleans a developer remaining on the intermediate image transfer member; and
a photoreceptor which transfers an image onto the intermediate image transfer member,
wherein the lubricant supplying device is arranged on a downstream side of the cleaning section and on an upstream side of the photoreceptor in a direction of rotation of the intermediate image transfer member.

15. An image forming apparatus comprising the lubricant supplying system of claim 1.

16. A lubricant supplying system comprising:
an image carrier;
a lubricant; and
a lubricant supplying device comprising:
a lubricant supplying member which is opposed to the image carrier without physical contact and holds the lubricant;
a contacting member for allowing the lubricant held on the lubricant supplying member to fly toward the image carrier by being brought in contact with the lubricant supplying member; and
a leveling member for leveling the lubricant attached to the image carrier by being brought in contact with the image carrier,
wherein the contacting member is arranged in a position so that a reaching range of the lubricant which flies toward the image carrier makes different distribution depending on a particle diameter of the lubricant and the lubricant having flown a prescribed distance attaches to the image carrier.

17. The lubricant supplying system of claim 16,
wherein the contacting member is arranged in the position so that a reaching range of a flying lubricant having a smaller particle diameter is longer than a reaching range of a flying lubricant having a larger particle diameter.

18. The lubricant supplying system of claim 16,
wherein the lubricant supplying member is arranged in a position where the lubricant held on the lubricant supplying member does not freely fall onto the image carrier.

19. The lubricant supplying system of claim 16,
wherein a contacting section of the leveling member is made of an elastic member, the contacting section coming in contact with the image carrier.

20. The lubricant supplying system of claim 16, which makes an electric field between the lubricant supplying member and the image carrier or between the contacting member and the image carrier.

21. An image forming apparatus comprising the lubricant supplying system of claim 16.
